(19) United States
(12) Patent Application Publication
(10) Pub. No.: US 2025/0181877 A1
(43) Pub. Date: Jun. 5, 2025

(54) CARD WITH DISPLAY

(71) Applicant: TOSHIBA GLOBAL COMMERCE SOLUTIONS, INC., Durham, NC (US)

(72) Inventor: Brad M. JOHNSON, Raleigh, NC (US)

(21) Appl. No.: 18/525,477

(22) Filed: Nov. 30, 2023

(51) Int. Cl. G06K 19/077

(52) U.S. Cl. CPC G06K 19/07707

(57) ABSTRACT

Described herein are an apparatus and method for displaying information on a card. An apparatus includes a card arranged to be scanned to conduct a transaction. The apparatus also includes a display attached to the card and a processor communicatively coupled to the display. The processor receives information about the transaction when the card is scanned presents the information on the display.

### BACKGROUND

During checkout, a user may scan a card (e.g., a debit card or a credit card) to pay for an item. The checkout system may process the card information to complete the transaction. The user, however, may not have a simple way to privately track the transaction made using the card. Instead, the user typically needs to access a service provided by the card or the retailer to track the transaction.

### BRIEF DESCRIPTION OF THE DRAWINGS

FIG. 1 illustrates an example system.

FIG. 2 illustrates an example card in the system of FIG. 1.

FIG. 3A illustrates an example card in the system of FIG. 1.

FIG. 3B illustrates an example display in the system of FIG. 1.

FIG. 4 illustrates an example operation for displaying information performed by the system of FIG. 1.

FIG. 5 illustrates an example operation for displaying information performed by the system of FIG. 1.

FIG. 6 illustrates an example operation for displaying information performed by the system of FIG. 1.

FIG. 7 illustrates an example operation for displaying information performed by the system of FIG. 1.

FIG. 8 is a flowchart of an example method performed by the system of FIG. 1.

FIG. 9 is a flowchart of an example method performed by the system of FIG. 1.

FIG. 10 is a flowchart of an example method performed by the system of FIG. 1.

### DETAILED DESCRIPTION

Accessing various retail-based services may expose a user's personal information to external parties, including malicious parties who may use that information to impersonate the user.

The present disclosure describes a card that includes a display. When the card is scanned to conduct a transaction, the card may download information about the transaction (e.g., vendor, price, etc.) and present that information on the display. A user may view the display on the card to see the information about the transaction. The user may also download the information from the card for tracking purposes. For example, the card may generate a barcode that encapsulates the information and present the barcode on the display. The user may then scan the barcode to download the information.

In certain embodiments, the card presents several technical advantages. For example, the card downloads and displays information about the transaction, which was information that was not previously accessible through the card. As another example, the card allows the user to download the information from the card, which provides the user a closed system to track and monitor transactions. In this manner, the card improves the privacy and security of the user's personal information. Additionally, in one embodiment, the card is powered when scanned rather than being constantly powered (e.g., by a battery). As a result, the card reduces electrical power consumption relative to battery-powered systems. Moreover, because the card downloads information about the transaction, the card removes the need for the checkout system to store and maintain the transaction information. As a result, the card improves the functioning of a computer system by reducing the amount of information stored and maintained by the computer system.

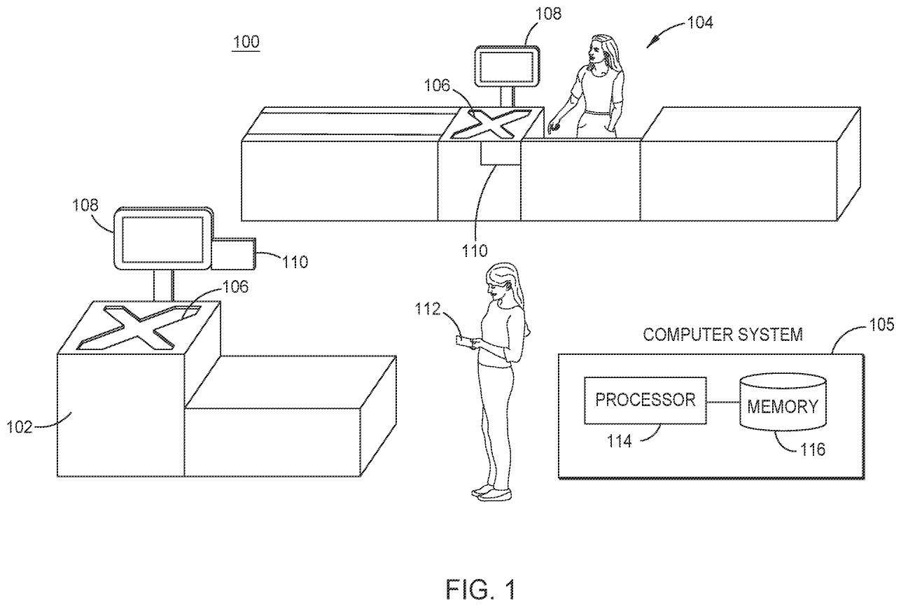

FIG. 1 illustrates an example system 100. Generally, the system 100 may be the checkout area of a store. Users may scan items in the checkout area to add the items to a transaction. For example, each item may be accompanied by a barcode that can be scanned to identify the item. The item may then be added to a transaction. As see in FIG. 1, the system 100 includes a checkout system 102, a checkout system 104, and a computer system 105.

The checkout systems 102 and 104 include scanners 106, displays 108, and card readers 110. The checkout system 102 is a self-checkout system, where a user may bring items to scan and purchase the items. The checkout system 104 is an assisted checkout system, where a clerk or associate scans items for a user. Generally, the scanner 106 is used to scan a barcode on an item. The checkout systems 102 and 104 may then identify the item based on the scanned barcode and add the item to a transaction. The display 108 may indicate the item that is added to the transaction. The user may use the card reader 110 to scan a card 112 to pay for the transaction.

Generally, when the card 112 is scanned, the checkout system 102 or 104 communicates information about the transaction to the card 112. For example, the checkout system 102 or 104 may transmit a vendor name, price for the transaction, etc. to the card 112 when the card 112 is scanned by the card reader 110. The card 112 includes a display that presents the information about the transaction. When the user retrieves the card 112 from the card reader 110, the user may view the display on the card 112 to see the information. The card 112 may present the information for a period of time (e.g., until a timeout has expired). The user may also download the information about the transaction from the card 112. For example, the card 112 may generate and present a barcode (e.g., a two-dimensional barcode, such as a quick-response (QR) code) on the display on the card 112. The barcode encapsulates the transaction information. When the user scans that barcode using a device of the user, the device downloads the transaction information from the card 112.

In this manner, the card 112 provides a closed environment in which the user may track and maintain transaction information. For example, because the card 112 maintains the transaction information from the checkout system 102 or 104, the user avoids having to provide personal information to another service (e.g., a service of the vendor or of a card provider) to access the transaction information. Instead, the user may download the information directly from the card 112. As a result, the security of the user's personal information and the security of the transaction information are improved.

The computer system 105 may be integrated with or separate from the checkout systems 102 and 104. The computer system 105 may be in communication with the checkout systems 102 and 104. Generally, the computer system 105 may assist in identifying items that are scanned by the scanners 106. For example, the computer system 105 may provide the checkout systems 102 and 104 with the identities and prices of scanned items. As seen in FIG. 1, the computer system 105 includes a processor 114 and a memory 116 that are arranged to perform the functions or actions of the computer system 105 described herein.

The processor 114 is any electronic circuitry, including, but not limited to one or a combination of microprocessors, microcontrollers, application specific integrated circuits (ASIC), application specific instruction set processor (ASIP), and/or state machines, that communicatively couples to the memory 116 and controls the operation of the computer system 105. The processor 114 may be 8-bit, 16-bit, 32-bit, 64-bit or of any other suitable architecture. The processor 114 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 114 may include other hardware that operates software to control and process information. The processor 114 executes software stored on the memory 116 to perform any of the functions described herein. The processor 114 controls the operation and administration of the computer system 105 by processing information (e.g., information received from the checkout system 102 or 104 and memory 116). The processor 114 is not limited to a single processing device and may encompass multiple processing devices contained in the same device or computer or distributed across multiple devices or computers. The processor 114 is considered to perform a set of functions or actions if the multiple processing devices collectively perform the set of functions or actions, even if different processing devices perform different functions or actions in the set.

The memory 116 may store, either permanently or temporarily, data, operational software, or other information for the processor 114. The memory 116 may include any one or a combination of volatile or non-volatile local or remote devices suitable for storing information. For example, the memory 116 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 116, a disk, a CD, or a flash drive. In particular embodiments, the software may include an application executable by the processor 114 to perform one or more of the functions described herein. The memory 116 is not limited to a single memory and may encompass multiple memories contained in the same device or computer or distributed across multiple devices or computers. The memory 116 is considered to store a set of data, operational software, or information if the multiple memories collectively store the set of data, operational software, or information, even if different memories store different portions of the data, operational software, or information in the set.

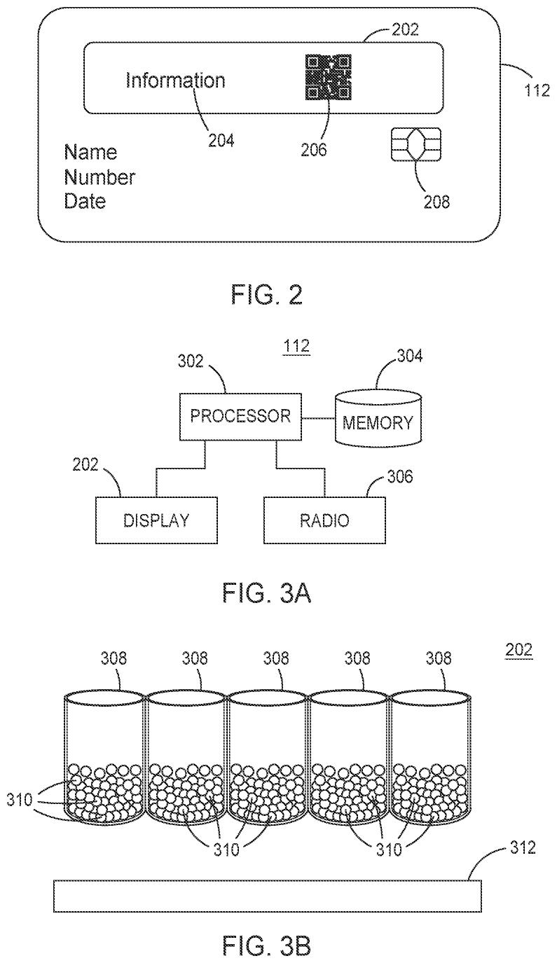

FIG. 2 illustrates an example card 112 in the system 100 of FIG. 1. As seen in FIG. 2, the card 112 includes a display 202. Generally, the card 112 receives information about a transaction when the card 112 is swiped or scanned by the card reader 110. The card 112 then presents the information about the transaction on the display 202 so that the user may view the information on the card 112.

A user may swipe or scan the card 112 to perform a transaction. For example, the card 112 may be a debit card or credit card that the user swipes or scans to purchase items. The card 112 may present information, such as a name of the user, a card number, or an expiration date on the surface of the card 112. For example, this information may be printed on a surface of the card 112. The display 202 may be attached to a surface of the card 112. Both the surface and the display 202 and may be visible when viewing the card 112. In the example of FIG. 2, the display 202 is attached to the same surface of the card 112 that shows the name, the card number, or the expiration date. The display 202 may be attached to the opposite surface of the card 112 in other embodiments. The display 202 may be smaller than the surface of the card 112 to which the display 202 is attached.

The display 202 may present information 204 about a transaction received by the card 112. For example, the card 112 may include an embedded radio or antenna that wirelessly receives the information 204 (e.g., from the checkout system 102 or 104) when the card 112 is swiped or scanned by the card reader 110. The card 112 then operates the display 202 to present the received information 204. In some embodiments, the display 202 is formed using tubes of different colored microcapsules. The card 112 applies an electric field to the tubes (e.g., using electrodes) to move microcapsules towards the surface of the display 202. For example, applying an electric field to a tube may cause black microcapsules to move towards the surface of the display 202, thereby creating a dark pixel. When an opposite electric field or no electric field is applied to the tube, the black microcapsules may move away from the surface of the display 202, thereby creating a blank or transparent pixel. Applying different electric fields to different tubes of the display 202 moves different colored microcapsules to different parts of the surface of the display 202 to form text or images. For example, applying different electric fields to different tubes of the display 202 may move different colored microcapsules to the surface of the display 202 to form the information 204. The user may then view the display 202 to see the information 204 on the surface of the card 112.

In some embodiments, the card 112 generates and presents a barcode 206 using the display 202. The barcode 206 may encapsulate or encode the information 204. For example, the barcode 206 may be a two-dimensional barcode (e.g., a QR code) that encapsulates or encodes the information 204. A user may scan the barcode 206 using a device of the user to download the information 204 to the device. In this manner, the user may use the device to track and maintain the information 204 without accessing an external service (e.g., a service of the vendor or of a card provider).

The card 112 may include a chip 208 embedded in the card 112. The chip 208 may be powered by a radio or an antenna embedded in the card 112. In some embodiments, that radio or antenna may also power the display 202. For example, the radio or antenna may harvest electrical energy wirelessly transmitted by the checkout system 102 or 104 (e.g., by the card reader 110) when the card 112 is swiped or scanned by the card reader 110. The electrical power may then be used to power the chip 208 and/or the display 202. The chip 208 may transmit (e.g., using a radio or antenna in the card 112) encrypted information when the card 112 is scanned or swiped. The encrypted information may be used to authenticate the card 112, which reduces the possibility of fraudulent transactions. In the example of FIG. 2, the chip 208 is visible on the surface of the card 112. Additionally, the surface of the card 112 is also visible. In some embodiments, the chip 208 is visible on the opposite surface of the card 112.

FIG. 3A illustrates an example card 112 in the system 100 of FIG. 1. As seen in FIG. 3A, the card 112 includes a processor 302, a memory 304, a display 202, and one or more radios 306. The processor 302 and memory 304 may perform the functions or actions of the card 112 described herein. For example, the processor 302 may process or analyze information received by the one or more radios 306. The processor 302 may then control the display 202 to display that information. The processor 302 may control electrodes that apply electric fields to different portions of the display 202 such that the display 202 presents the information received by the one or more radios 306.

The processor 302 is any electronic circuitry, including, but not limited to one or a combination of microprocessors, microcontrollers, application specific integrated circuits (ASIC), application specific instruction set processor (ASIP), and/or state machines that communicatively couples to the memory 304 and controls the operation of the card 112. The processor 302 may be 8-bit, 16-bit, 32-bit, 64-bit or of any other suitable architecture. The processor 302 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 302 may include other hardware that operates software to control and process information. The processor 302 executes software stored on the memory 304 to perform any of the functions described herein. The processor 302 controls the operation and administration of the card 112 by processing information (e.g., information received from the checkout system 102 or 104, radio 306, and memory 304). The processor 302 is not limited to a single processing device and may encompass multiple processing devices contained in the same device or computer or distributed across multiple devices or computers. The processor 302 is considered to perform a set of functions or actions if the multiple processing devices collectively perform the set of functions or actions, even if different processing devices perform different functions or actions in the set.

The memory 304 may store, either permanently or temporarily, data, operational software, or other information for the processor 302. The memory 304 may include any one or a combination of volatile or non-volatile local or remote devices suitable for storing information. For example, the memory 304 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 304, a disk, a CD, or a flash drive. In particular embodiments, the software may include an application executable by the processor 302 to perform one or more of the functions described herein. The memory 304 is not limited to a single memory and may encompass multiple memories contained in the same device or computer or distributed across multiple devices or computers. The memory 304 is considered to store a set of data, operational software, or information if the multiple memories collectively store the set of data, operational software, or information, even if different memories store different portions of the data, operational software, or information in the set.

The one or more radios 306 include antennas that wirelessly transmit or receive signals. For example, the one or more radios 306 may wirelessly receive signals transmitted by a checkout system 102 or 104 or by a device of a user. The radios 306 may communicate these signals to the processor 302. The processor 302 may analyze these signals to determine information within the signals (e.g., information about a transaction). The processor 302 may then operate the display 202 to present the information.

FIG. 3B illustrates an example display 202 in the card 112. As seen in FIG. 3B, the display 202 includes multiple tubes 308. The tubes 308 are positioned next to each other. A tube 308 (or a set of tubes 308) may form a pixel on the display 202. Each tube 308 holds microcapsules 310. The microcapsules 310 may be different colors. For example, some microcapsules 310 in a tube 308 may be black, and some microcapsules 310 in the tube 308 may be transparent or white.

The display 202 also includes one or more electrodes 312 positioned by the tubes 308. When electric power is applied to an electrode 312, the electrode 312 produces an electric field. The electric field moves certain microcapsules 310 in a tube 308 towards a different end of the tube 308. For example, applying a certain electric field to the tube 308 may move the black microcapsules 310 towards another end of the tube 308. That end of the tube 308 may form a surface of the display 202. As a result, the black microcapsules 310 are moved towards the surface of the display 202 to form a black pixel. When another electric field is applied to the tube 308, the white or transparent microcapsules 310 are moved to the surface of the display 202 and the black microcapsules 310 are moved away from the surface of the display, forming a white or transparent pixel. In this manner, the electrode 312 is used to control what is displayed on the display 202. In some embodiments, the display 202 includes multiple electrodes 312, with each electrode 312 controlling the microcapsules 310 in a subset of the tubes 308. Powering or not powering the different electrodes 312 forms different letters, words, or images on the display 202.

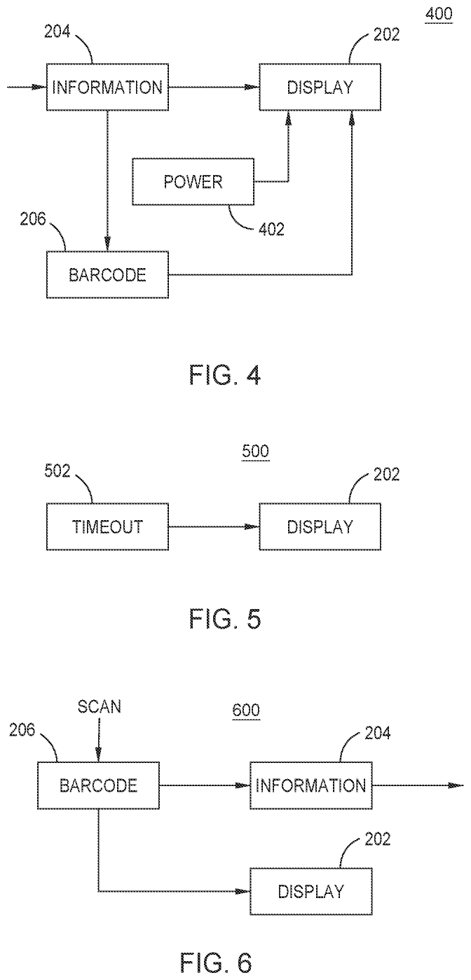

FIG. 4 illustrates an example operation 400 for displaying information performed by the system 100 of FIG. 1. In particular embodiments, the card 112 performs the operation 400. By performing the operation 400, the card 112 presents information on the display 202 attached to the card 112.

The card 112 receives the information 204. For example, the card 112 may receive the information 204 using the one or more radios 306 embedded in the card 112 when the card 112 is swiped or scanned by the card reader 110. The card 112 may have been swiped or scanned to pay for a transaction. While the card 112 is being swiped or scanned, the checkout system 102 or 104 (e.g., the card reader 110) may wirelessly transmit the information 204 about the transaction to the card 112. The card 112 may receive the information 204 using the one or more radios 306 embedded in the card 112. The information 204 may include information about the transaction (e.g., a price of the transaction, a vendor name, etc.).

The card 112 then presents the information 204 on the display 202. For example, the card 112 may apply electric fields to different portions of the display 202 to cause the display 202 to display the information 204. In this manner, the card 112 presents the information 204 about the transaction on the surface of the card 112. The display 202 may receive electrical power 402 from the one or more radios 306 embedded in the card 112. For example, the power 402 may power electrodes that apply the electric field to the different portions of the display 202.

In certain embodiments, the card 112 also generates a barcode 206 that encapsulates or encodes the information at 204. The barcode 206 may be a two-dimensional barcode (e.g., a QR code) that encodes or encapsulates the information 204 in a pictorial form. The card 112 may present the barcode 206 on the display 202 (e.g., along with the information 204). The barcode 206 may then be scanned to download the information 204 from the card 112.

FIG. 5 illustrates an example operation 500 for displaying information performed by the system 100 of FIG. 1. In particular embodiments, the card 112 performs the operation 500. As seen in FIG. 5, the card 112 implements a timeout 502 that controls for how long information is presented on the display 202. For example, when the card 112 presents the information 204 about the transaction on the display 202, the card 112 may start a timer. The timer may count up towards the timeout 502, or the timer may be set at the timeout 502 and count down towards zero. When the timeout 502 has been reached, the card 112 may wipe or remove the information 204 from the display 202. As a result, the display 202 may stop presenting the information 204 about the transaction. In this manner, the card 112 may limit for how long the display 202 presents the information 204 about the transaction, which improves the security of the information 204.

FIG. 6 illustrates an operation 600 for displaying information performed by the system 100 of FIG. 1. In particular embodiments, the card 112 performs the operation 600. As seen in FIG. 6, the card 112 displays the barcode 206. As discussed previously, the barcode 206 may be a two-dimensional barcode that encapsulates or encodes the information 204 about the transaction. The card 112 may present the barcode 206 on the display 202.

When the barcode 206 is scanned by a user's device (e.g., a mobile phone), the device may effectively download the information 204 from the card 112. Because the barcode 206 encapsulates or encodes the information 204, the user's device may download the information 204 by scanning the barcode 206. The card 112 may detect that the barcode 206 has been scanned by the user's device. For example, when the user's device scans the barcode 206 and downloads the information 204, the user's device may transmit or broadcast a wireless signal that indicates that the barcode 206 has been scanned. The card 112 may use the one or more radios 306 to receive the signal transmitted by the user's device. When the card 112 receives the signal, the card 112 may determine that the barcode 206 has been scanned. In response, the card 112 may wipe or remove the information 204 from the display 202. Stated differently, when the card 112 detects that the user's device has downloaded the information 204 from the card 112, the card 112 may remove the information 204 from the display 202, which improves the security of the information 204.

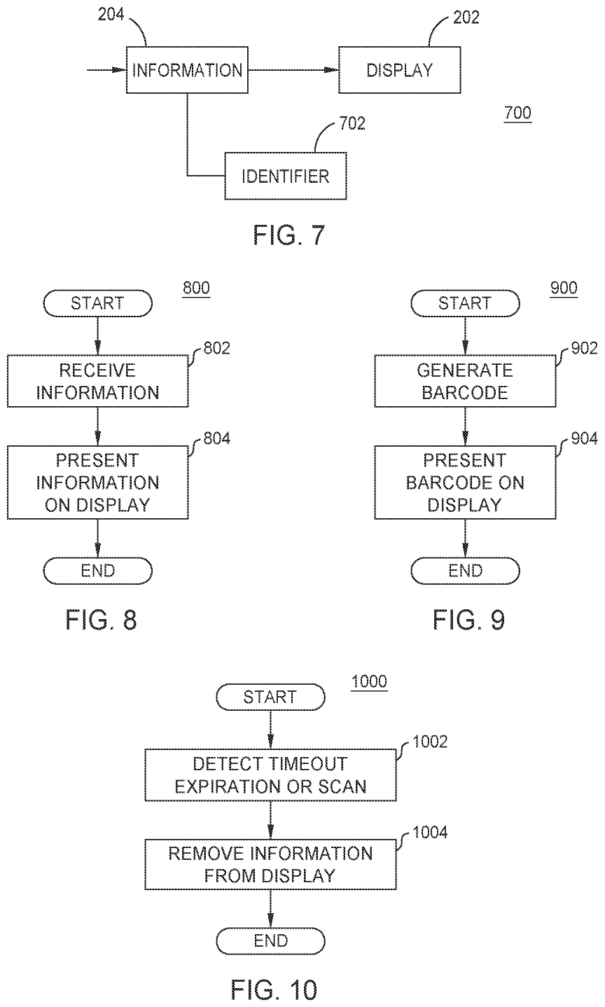

FIG. 7 illustrates an example operation 700 for displaying information performed by the system 100 of FIG. 1. In particular embodiments, the card 112 performs the operation 700. By performing the operation 700, the card 112 receives and presents identifying information of the user of the card 112.

The card 112 may receive the information 204 about the transaction when the card 112 is swiped or scanned by the card reader 110. The information 204 may include an identifier 702 for the user (e.g., an owner of the card 112). For example, the identifier 702 may be an identification code on a loyalty tag of the user. The card 112 may encapsulate or encode the identifier 702 into the barcode 206 along with the information 204 about the transaction. The card 112 may then present the barcode on the display 202. When the barcode 206 is scanned, the information 204 along with the identifier 702 may be downloaded. In this manner, the information 204 about the transaction may be grouped by or tracked with the identifier 702 of the user.

FIG. 8 is a flowchart of an example method 800 performed by the system 100 of FIG. 1. In particular embodiments, the card 112 performs the method 800. By performing the method 800, the card 112 receives and presents information 204 about a transaction on a display 202 attached to the surface of the card 112.

In block 802, the card 112 receives the information 204. The card 112 may receive the information 204 when the card 112 is swiped or scanned by the card reader 110 to pay for a transaction. The checkout system 102 or 104 (e.g., the card reader 110) may wirelessly transmit the information 204 while the card 112 is being swiped or scanned. The card 112 may use one or more radios 306 embedded within the card 112 to receive the information 204.

In block 804, the card 112 presents the information 204 on the display 202 attached to the surface of the card 112. For example, the card 112 may apply an electric field to different portions of the display 202 to move microcapsules contained within tubes in the display 202 to the surface of the card 112. The different colored microcapsules may form words or numbers on the display 202 to present the information 204. In this manner, the user may see the information 204 without accessing an external service (e.g., a service of the vendor or of a card provider).

FIG. 9 is a flowchart of an example method 900 performed by the system 100 of FIG. 1. In particular embodiments, the card 112 performs the method 900. By performing the method 900, the card 112 provides the barcode 206 that encapsulates or encodes the information 204 about the transaction.

In block 902, the card 112 generates the barcode 206. The card 112 may receive the information 204 from the card reader 110 when the card is being swiped or scanned. The card 112 may then encapsulate or encode the information 204 into the barcode 206. The barcode 206 may be a two-dimensional barcode (e.g., a QR code).

In block 904, the card 112 presents the barcode 206 on the display 202. After generating the barcode 206, the card 112 may communicate the barcode 206 to the display 202. The card 112 may apply an electric field to different portions of the display 202 to cause different colored microcapsules to move within tubes that form the display 202. The different colored microcapsules may then be arranged to present the barcode 206. The user may then use a device to scan the barcode 206 to download the information 204 about the transaction from the card 112.

FIG. 10 is a flowchart of an example method 1000 performed by the system 100 of FIG. 1. In particular embodiments, the card 112 performs the method 1000. By performing the method 1000, the card 112 limits the amount of time for which the information 204 is presented on the display 202.

In block 1002, the card 112 detects a timeout expiration or a scan. For example, the card 112 may detect that the timeout 502 has expired, or the card 112 may detect that the barcode 206 has been scanned to download the information 204. The scanning device may transmit a signal that the card 112 receives (e.g., using the one or more radios 306). When the card 112 receives the signal, the card 112 may determine from the signal that the barcode 206 has been scanned.

In block 1004, the card 112 removes the information 204 from the display 202 in response to the card 112 detecting that the timeout 502 has expired or that the barcode 206 has been scanned. For example, the card 112 may change the electric field applied to the tubes that form the display 202 to create blank or transparent pixels. By removing the information 204 from the display 202, the card 112 improves the security of the information 204.

In summary, the card 112 includes a display 202. When the card 112 is scanned to conduct a transaction, the card 112 may download information 204 about the transaction (e.g., vendor, price, etc.) and present that information 204 on the display 202. A user may view the display 202 on the card 112 to see the information 204 about the transaction. The user may also download the information 204 from the card 112 for tracking purposes. For example, the card 112 may generate a barcode 206 that encapsulates the information 204 and present the barcode 206 on the display 202. The user may then scan the barcode 206 to download the information 204.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present disclosure describes a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present disclosure, other and further embodiments may be devised without departing from the basic scope thereof, and the scope thereof is determined by the claims that follow.

1. An apparatus comprising:
a card arranged to be scanned to conduct a transaction;
a display attached to the card, wherein the display comprises microcapsules; and
a processor communicatively coupled to the display, wherein the processor is configured to:
receive information about the transaction when the card associated with a user is scanned;
generate a two-dimensional graphical element that encapsulates the information about the transaction and an identifier of the user;
apply an electric field to the display to move the microcapsules to generate a graphical depiction of the information and the two-dimensional graphical element on the display;
detect that a timeout expires; and
based on the timeout expiring, adjust the electric field to move the microcapsules to remove the generated graphical depiction of the information from the display.

2. (canceled)

3. The apparatus of claim 1, further comprising a radio communicatively coupled to the processor, wherein the radio is arranged to wirelessly receive the information when the card is scanned and to communicate the information to the processor.

4. The apparatus of claim 3, wherein the radio is further arranged to electrically power the processor and the display.

5. (canceled)

6. The apparatus of claim 1, wherein the processor is further configured to detect that the two-dimensional graphical element has been scanned by a user device to download the information to the user device.

7. The apparatus of claim 6, wherein the processor is further configured to refrain from presenting the information on the display in response to detecting that the two-dimensional graphical element has been scanned.

8. The apparatus of claim 1, wherein the information comprises at least one of a vendor name or a price of the transaction.

9. The apparatus of claim 1, wherein the card is a debit card or a credit card.

10. The apparatus of claim 1, wherein the processor is further configured to generate a two-dimensional barcode that encapsulates an identifier for an owner of the card.

11. A method comprising:
receiving, by a processor communicatively coupled to a display attached to a card associated with a user, information about a transaction when the card is scanned to conduct the transaction, wherein the display comprises microcapsules;
generating a two-dimensional graphical element that encapsulates the information about the transaction and an identifier of the user;
applying an electric field to the display to move the microcapsules to generate a graphical depiction of the information and the two-dimensional graphical element on the display;
detecting that a timeout expires; and
based on the timeout expiring, adjusting the electric field to move the microcapsules to remove the generated graphical depiction of the information from the display.

12. (canceled)

13. The method of claim 11, further comprising:
wirelessly receiving, by a radio communicatively coupled to the processor, the information when the card is scanned; and
communicating the information to the processor.

14. The method of claim 13, further comprising electrically powering, by the radio, the processor and the display.

15. (canceled)

16. The method of claim 11, further comprising detecting, by the processor, that the two-dimensional graphical element has been scanned by a user device to download the information to the user device.

17. The method of claim 16, further comprising refraining, by the processor, from presenting the information on the display in response to detecting that the two-dimensional graphical element has been scanned.

18. The method of claim 11, wherein the information comprises at least one of a vendor name or a price of the transaction.

19. The method of claim 11, further comprising generating, by the processor, a two-dimensional barcode that encapsulates an identifier for an owner of the card.

20. A system comprising:
a card comprising a display attached to the card, wherein the display comprises microcapsules, and wherein the card is associated with a user; and
a checkout system arranged to scan the card to conduct a transaction, wherein the checkout system transmits information about the transaction to the card when the card is scanned, and wherein the card (i) generates a two-dimensional graphical element that encapsulates the information about the transaction and an identifier of the user, (ii) applies an electric field to the display to move the microcapsules to generate a graphical depiction of the information and the two-dimensional graphical element on the display (iii) detects that a timeout expires, and (iv) based on the timeout expiring, adjusts the electric field to move the microcapsules to remove the generated graphical depiction of the information from the display.
